(19) United States
(12) Patent Application Publication
(10) Pub. No.: US 2009/0190277 A1
(43) Pub. Date: Jul. 30, 2009

(54) ESD Protection For USB Memory Devices

(75) Inventors: Siew S. Hiew, San Jose, CA (US); Nan Nan, San Jose, CA (US); Abraham C. Ma, Fremont, CA (US)

Correspondence Address: BEVER HOFFMAN & HARMS, LLP;901 Campisi Way, Suite 370, Campbell, CA, 95008, US

(73) Assignee: Super Talent Electronics, Inc., San Jose, CA (US)

(21) Appl. No.: 12/419,187

(22) Filed: Apr. 6, 2009

Related U.S. Application Data
(63) Continuation-in-part of application No. 12/124,081, filed on May 20, 2008.
Application No. 12/124,081 is a continuation-in-part of application No. 11/866,927, filed on Oct. 3, 2007.
Application No. 11/866,927 is a continuation-in-part of application No. 11/864,696, filed on Sep. 28, 2007.

(51) Int. Cl. H02H 9/00

(52) U.S. Cl. 361/56

(57) ABSTRACT

ESD protection for a portable electronic device is provided by sandwiching a metal ground layer between prepreg (i.e., FR4 or other non-conductive PCB material) layers to form an ESD preventive PCB structure, where the metal ground layer is electrically connected to one or more of the integrated circuit (IC) components (e.g., at least one controller die, a non-volatile memory die, oscillator and passive components) that are mounted on the PCB by way of conductive via structures, and is accessible by way of one or more conductive anchor hole structures to external grounding structures. The one or more conductive anchor hole structures are positioned such that the metal ground layer is automatically electrically connected to the chassis ground of a host system when the portable device is coupled to a plug structure of the host system, e.g., by way of a metal connector jacket.

### RELATED APPLICATIONS

This application is a continuation-in-part (CIP) of U.S. Patent application for “Backward Compatible Extended USB Plug and Receptacle with Dual Personality”, U.S. application Ser. No. 11/864,696, filed Sep. 28, 2007.

This application is also a continuation-in-part (CIP) of U.S. Patent application for “Extended USB Plug, USB PCBA, and USB Flash Drive with Dual Personality” U.S. application Ser. No. 11/866,927, filed Oct. 3, 2007.

This application is also a continuation-in-part (CIP) of U.S. Patent application for “Extended COB-USB with Dual-Personality Contacts” U.S. application Ser. No. 12/124,081, filed May 20, 2008.

This application is also related to U.S. Patent application for “Extended Secure-Digital Card Devices and Hosts” U.S. application Ser. No. 10/854,004, filed May 25, 2004, which is a continuation-in-part of U.S. patent application Ser. No. 10/708,172, filed Feb. 12, 2004, now U.S. Pat. No. 7,021,971.

This application is also related to U.S. Patent application for “Extended USB Dual-Personality Card Reader” U.S. application Ser. No. 11/927,549, filed Oct. 29, 2007, now U.S. Pat. No. 7,440,286.

### FIELD OF THE INVENTION

This invention relates to portable devices that communicate with a host system by way of a connector, and more particularly to Universal Serial Bus (USB) type flash-type memory devices.

### BACKGROUND OF THE INVENTION

Universal-Serial-Bus (USB) has been widely deployed as a standard bus for connecting peripherals such as digital cameras and music players to personal computers (PCs) and other devices. Currently, the top transfer rate of USB is 480 Mb/s, which is quite sufficient for most applications. Faster serial-bus interfaces are being introduced to address different requirements. PCI Express, at 2.5 Gb/s, and SATA, at 1.5 Gb/s and 3.0 Gb/s, are two examples of high-speed serial bus interfaces for the next generation devices, as are IEEE 1394 and Serial Attached Small-Computer System interface (SCSI).

FIG. 15(A) shows a prior-art peripheral-side USB connector. USB connector 10 may be mounted on a board in the peripheral. USB connector 10 can be mounted in an opening in a plastic case (not shown) for the peripheral. USB connector 10 contains a small connector substrate 14, which is often white ceramic, black rigid plastic, or another sturdy substrate. Connector substrate 14 has four or more metal contacts 16 formed thereon. Metal contacts 16 carry the USB signals generated or received by a controller chip in the peripheral. USB signals include power, ground, and serial differential data D+, D−. USB connector 10 contains a metal case that wraps around connector substrate 14. The metal case touches connector substrate 14 on three of the sides of connector substrate 14. The top side of connector substrate 14, holding metal contacts 16, has a large gap to the top of the metal case. On the top and bottom of this metal wrap are formed holes 12. USB connector 10 is a male connector, such as a type-A USB connector.

FIG. 15(B) shows a female USB connector. Female USB connector 20 can be an integral part of a host or PC, or can be connected by a cable. Another connector substrate 22 contains four metal contacts 24 that make electrical contact with the four metal contacts 16 of the male USB connector 10 of FIG. 15(A). Connector substrate 22 is wrapped by a metal case, but small gaps are between the metal case and connector substrate 22 on the lower three sides. Locking is provided by metal springs 18 in the top and bottom of the metal case. When male USB connector 10 of FIG. 15(A) is flipped over and inserted into Female USB connector 20 of FIG. 15(B), metal springs 18 lock into holes 12 of male USB connector 10. This allows the metal casings to be connected together and grounded. Universal-Serial-Bus (USB) is a widely used serial-interface standard for connecting external devices to a host such as a personal computer (PC). Another new standard is PCI Express, which is an extension of Peripheral Component Interconnect (PCI) bus widely used inside a PC for connecting plug-in expansion cards. An intent of PCI Express is to preserve and re-use PCI software. Unfortunately, USB connectors with their four metal contacts do not support the more complex PCI Express standard.

FIGS. 16(A) and 16(B) show an ExpressCard and its connector. A new removable-card form-factor known as ExpressCard has been developed by the Personal-Computer Memory Card International Association (PCMCIA), PCI, and USB standards groups. ExpressCard 26 is about 75 mm long, 34 mm wide, and 5 mm thick and has ExpressCard connector 28.

FIG. 16(B) shows that ExpressCard connector 28 fits into connector or socket 30 on a host when ExpressCard 26 is inserted into an ExpressCard slot on the host. Since ExpressCard connector 28 and socket 30 are 26-pin connectors, they contain many more signals than a 4-pin USB connector. The additional PCI-Express interface can be supported as well as USB. ExpressCard 26 can also use USB to communicate with the host. Differential USB data signals USBD+ and USBD− are connected between ExpressCard 26 and a host chip set. The host chip set contains a USB host controller to facilitate communication with ExpressCard 26.

PCI Express supports data rates up to 2.5 G/b, much higher than USB. While the ExpressCard standard is useful for its higher possible data rate, the 26-pin connectors and wider card-like form factor limit the use of ExpressCards. The smaller USB connector and socket are more desirable than the larger ExpressCard. Another interface, serial ATattachment (SATA) supports data rates of 1.5 Gb/s and 3.0 Gb/s. However, SATA uses two connectors, one 7-pin connector for signals and another 15-pin connector for power. Due to its clumsiness, SATA is more useful for internal storage expansion than for external peripherals. While SATA and ExpressCard are much higher-speed interfaces than USB, they use larger, bulky connectors while USB has a single, small connector.

Electrostatic discharge (ESD) is the sudden and momentary electrostatic discharge from the highly charged source to any lower potential objects. Often time, the static charge can spark through air gap especially between two pointed ends where the charge origin is most concentrated. The ESD term is usually used in the semiconductor and electronic industries to describe momentary unwanted spike currents that may cause damage to electronic component or equipment.

Electrostatic discharge is either generated from friction of two or more insulators and from the induction of charge on conductor or insulator from touching or get near a highly charge body. The electrostatic charge can spark across an air gap when the static field is high enough to arc (ionized conductive path) across an air gap between two pointed objects where the charge is most concentrated. This spark can cause serious damage to the electronic devices and equipments and able to ignites combustible gases that are floating in the air.

There are many methods of preventing ESD induced damage to semiconductor IC and electronic devices; the most effective method is to create EPA (Electrostatic Protective Area) where the workstations or manufacturing areas of electronic devices is taking preventive measures such as ESD floor mat, benches and workstations are properly grounded. Ionic emitters or fans can be deployed for ESD sensitive gadgets, devices and equipments. The purpose of having an EPA is to provide an environment of low charge in the vicinity of ESD sensitive electronics with all conductive materials are grounded; workers are wearing anti-static garments and wear ESD wrist straps or foot straps to ensure unwanted charge buildup in their body. All packing materials for the shipment of ESD sensitive electronics are packed in appropriate ESD-safe antistatic packing material.

Manufacturers can take the above mentioned methods to protect their ESD sensitive devices or equipments to avoid ESD. Due to dielectric nature of electronics component and assemblies, electrostatic charging can not be completely prevented during handling of devices especially portable electronic devices or USB type memory storage devices. Consumers handling of electronic devices may not take such precaution extend as the manufacturing environment to protect the consumer electronic they bought. Thus, consumer electronic ought to have high ESD threshold to ensure the reliability and quality of the devices. There is a need to build an efficient ESD proof device with low added cost to manufacturing process.

Present ESD protection practices include the following approaches. A first approach involves relying on the connector signal ground to conduct unwanted electrostatic charges via the host socket signal ground to the chassis ground. Normally the PCB traces on the PCBA are thin and lengthy which create a higher resistive path for the unwanted electrostatic charge to dissipate. A second approach is taught in U.S. Pat. No. 7,410,370, which teaches a connector for preventing electrostatic discharge during connection of a USB-type connector. The connector has a grounding clip affixed to the signal ground pin at proximal end and with the distal end raised above the base block through the recess to make contact with the shroud. Accordingly, any ESD built up in the shroud travels from the shroud, through the ESD grounding clip, to the signal ground pin where it is harmlessly dissipated. A second approach is taught in U.S. Pat. No. 7,416,419, which teaches a USB flash memory unit having an electrically conductive housing that includes a spring that provides an electrically conductive, low-resistance pathway between the housing and the metal shell of USB connector so that electrostatic charge can directly discharge from the housing to the metal shell instead of discharging through electronic components within the housing. The metal shell is cut and down-set from the metal body with the protruded open end to make direct contact with the housing.

The ESD protection device described above has a few problems; firstly, electrostatic charge will select a lower resistive path to discharge electrostatic charge rather than higher resistive path. The shroud is made of metal in typical USB devices. The metal shroud can dissipates unwanted electrostatic charge more than the USB signal ground. Thus, ESD should come from the electronic components to the metal shroud instead of the other way around. Secondly, the invention requires a new split-level base block with recess to accommodate the grounding clip. Thirdly, it requires additional process step to attach the grounding clip to the base block.

What is needed is an effective method to dissipate unwanted electrostatic charge from the USB memory device to a large body of ground plane, such as the chassis ground of the host device (e.g., desk top PC, note book computer, digital camera, or medical equipment).

### SUMMARY OF THE INVENTION

This invention relates to the ESD protection for a portable electronic device in which a metal ground layer is sandwiched between prepreg (i.e., FR4 or other non-conductive PCB material) layers to form an ESD preventive PCB structure, wherein the metal layer is electrically connected to one or more of the integrated circuit (IC) components (e.g., at least one controller die, a non-volatile memory die, oscillator and passive components) that are mounted on the PCB by way of conductive via structures, and is accessible by way of one or more conductive anchor hole structures to external grounding structures. The metal (e.g., copper) ground layer has a footprint that is substantially identical to the prepreg layers (i.e., such that side edges of the ground layer are exposed around the peripheral edge of the PCB), and has a thickness in the range of 0.008 mm and 0.017 mm to provide reliable electrical conduction with low electrical resistance for conducting or dissipating unwanted electrostatic charge from the fragile electronic component. The one or more conductive anchor hole structures are positioned such that the metal ground layer is automatically electrically connected to the chassis ground of a host system when the portable device is coupled to a plug structure of the host system, thereby forming a pragmatic and effective method of ESD protection for portable electronic devices that has low added manufacturing cost in the formation of the PCB, and no additional process steps are needed in the device assembly process.

According to a specific embodiment of the present invention, a USB flash memory device includes a metal connector jacket that is mounted onto an ESD preventive PCB structure such that claws protruding from the connector jacket extend into the conductive anchor hole structures to provide electrical connection between the connector jacket and the metal ground layer. The connector jacket serves as an external grounding structure that facilitates reliable grounding of the USB flash memory device to the chassis ground of a host system by way of contact between the connector jacket and the host receptacle, which is also made of metal, thereby providing a low resistance discharge path for ESD generated on any region of the PCBA to drain to the ground plane, as well as to a much larger ground plane provided by the chassis ground of the host device before damaging the fragile IC components on the PCB.

As disclosed below, the ESD preventive PCB structure is designed for many types of portable electronic devices, although it is described with particular reference to electronic devices such as those that utilize the Universal-Serial-Bus specifications (e.g., Extended USB, USB 2.0 and other USB devices). The present invention may also be utilized in other portably electronic device types, such as chip-on-board (COB) USB devices, (Non Backward Compatible (NBC) COB Extended USB devices, SATA, and PCI-Express type portable devices.

### BRIEF DESCRIPTION OF THE DRAWINGS

These and other features, aspects and advantages of the present invention will become better understood with regard to the following description, appended claims, and accompanying drawings, where:

FIG. 1 is an exploded top perspective view showing an Extended USB flash memory device including a laminated ESD preventing PCB having an added copper ground plane according to an embodiment of the present invention;

FIG. 2 is a top perspective view showing the laminated ESD preventing PCB of FIG. 1 in an assembled state;

FIGS. 3(A) and 3(B) are enlarged perspective views showing portions of the PCB of FIG. 2, and in particular showing conductive structures in connection with the copper ground plane of the PCB;

FIG. 4 is an exploded top perspective view showing an assembly process in which a metal USB connector jacket is mounted onto the PCB structure of FIG. 2 by way of the anchor hole depicted in FIG. 3;

FIGS. 5(A) and 5(B) are bottom perspective views showing the metal USB connector jacket mounted onto the PCB structure of FIG. 2 before and after an SMT process;

FIGS. 6(A) and 6(B) are top perspective views showing an extending/retracting type USB device housing the PCB of FIG. 5(B);

FIG. 7 shows an explode top perspective view of the USB 2.0 ESD preventing PCB with the added copper ground plane and the laminated PCB substrate according to another embodiment of the present invention;

FIG. 8 is a top perspective view showing USB 2.0 ESD preventing PCB with IC memory devices and other IC devices mounted thereon;

FIG. 9 is an exploded top perspective view showing an assembly process in which a metal USB connector jacket is mounted onto the PCB structure of FIG. 8;

FIG. 10 is a perspective top view showing a chip-on-board (COB) type Extended USB device including an ESD preventing PCB according to another embodiment of the present invention;

FIG. 11 is a cross-sectional side view showing the COB-type Extended USB device of FIG. 10 in additional detail;

FIGS. 12(A) and 12(B) are partial cross-sectional side views showing portions of the COB-type Extended USB device of FIG. 10 in additional detail according to two alternative specific embodiments;

FIG. 13(A) is a perspective top view showing a COB-type USB 2.0 device including an ESD preventing PCB according to an other embodiment of the present invention;

FIG. 13(B) is a perspective top view showing a COB-type Non-Backward Compatible (NBC) USB device including an ESD preventing PCB according to an other embodiment of the present invention;

FIG. 14 is an exploded perspective view showing a USB assembly including the COB-type NBC USB device of FIG. 15 an a metal housing according to another embodiment of the present invention;

FIG. 15(A) and FIG. 15(B) show a prior art USB 2.0 male connector and a USB 2.0 female cable receptacle, respectively; and

FIG. 16(A) and FIG. 16(B) show a prior art PCI express card and its connector.

### DETAILED DESCRIPTION OF THE DRAWINGS

The present invention relates to an improvement in ESD protection for portable USB devices (e.g., USB memory devices). The following description is presented to enable one of ordinary skill in the art to make and use the invention as provided in the context of a particular application and its requirements. As used herein, directional terms such as “upper”, “upwards”, “lower”, “downward”, “front”, “rear”, are intended to provide relative positions for purposes of description, and are not intended to designate an absolute frame of reference. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

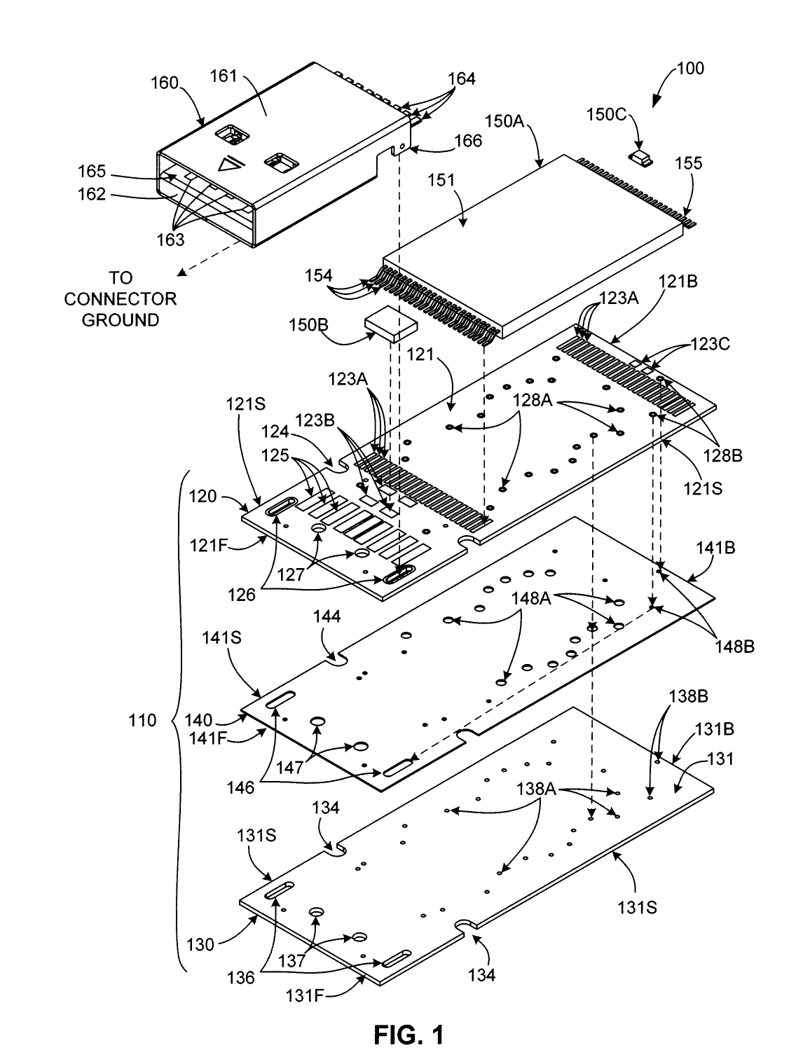

FIG. 1 is an exploded top perspective view showing a portion of a portable Extended USB flash memory device 100 including a laminated ESD preventing PCB 110 according to an embodiment of the present invention. ESD preventing PCB 110 differs from conventional PCBs for portable electronic devices in that PCB 110 includes a metal ground layer 140, which has the characteristics described below, that is used for dissipating ESD charges in a way that prevents damage to flash memory device 100. In addition to PCB 110, USB flash memory device 100 includes at least one IC component (e.g., a nonvolatile memory device 150A or LED 150C and a plug connector assembly 160 that are mounted onto PCB 110 in the manner described below.

As indicated in FIG. 1, ESD preventing PCB 110 is a laminated structure including an upper (first) prepreg layer 120, a lower (second) prepreg layer 130, and metal ground layer 140 sandwiched between upper prepreg layer 120 and lower prepreg layer 130. As is known in the art, each prepreg layer 120 and 130 includes one or more layers of a non-conductive material (e.g., FR4) that supports multiple laminated metal traces for transmitting signals between various points on PCB 110, and includes several alignment features and copper film structures that are described in the following paragraphs.

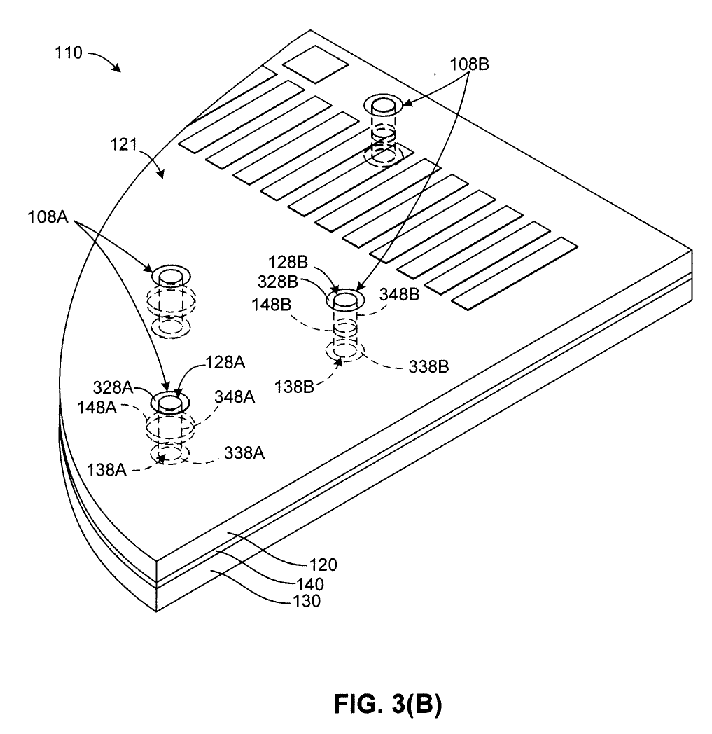

Referring to the middle of FIG. 1, upper prepreg layer 120 has an upper surface 121 facing away from metal ground layer 140, a lower surface facing metal ground layer 140, side edges 121S, a front edge 121F, and a back edge 121B. Two rows of copper finger pads 123A are disposed on upper surface 121 that facilitate surface mounting of nonvolatile memory device 150A in the manner described below. Additional copper surface mount pads 123B and 123C are disposed on opposite sides of finger pads 123A to facilitating surface-mounting an oscillator component 150B and an LED component 150C, respectively. Two alignment notches 124 are defined in side edges 121S for positioning in a device housing in the manner described below. A plurality of connector lead pads 125 are formed on upper surface 121 adjacent to front edge 121F for connecting to leads 167 extending from the back end of plug connector assembly 160. In the present “Extended USB” embodiment, there are nine connector lead pads 125. Two connector anchor holes 126, each having an internal metal wall as described below with reference to FIG. 3, are disposed adjacent to front edge 121F and serve to electrically connect metal ground layer 140 to plug connector assembly 160. Two alignment holes 127 are defined through upper prepreg layer 120 between connector lead pads 125 and front edge 121F for receiving poles protruding from a base unit (not shown) of connector assembly 160 for purposes of alignment and rigid support. A plurality of first via holes 128A are defined through upper prepreg layer 120 and aligned with openings 148A defined in metal ground layer 140. As described below, via holes 128A are subsequently filled with metal (e.g., copper) during a via or buried via plating process to facilitate the transmission of signals between wire traces (not shown) disposed on upper prepreg layer 120 and corresponding wire traces (not shown) disposed on lower prepreg layer 130. One or more second via holes 128B extend through upper prepreg layer 120 and are aligned with smaller ground pin openings 148B disposed on metal ground layer 140 such that, after the plating process described below, electrical connections are provided between metal ground layer 140 and ground terminals of selected components 150A, 150B and 150C.

Referring to the bottom of FIG. 1, lower prepreg layer 130 includes features similar to those of upper prepreg layer 120. Lower prepreg layer 130 has an upper surface 131 that faces metal ground layer 140, a lower surface that faces away from metal ground layer 140, side edges 131S, a front edge 131F, and a back edge 131B. Copper pads (not shown) are disposed on the lower surface of lower prepreg layer 130 to facilitate surface mounting of electrical and electronic components in the manner described above with reference to upper prepreg layer 120. Two alignment notches 134, two connector anchor holes 136, and two alignment holes 137 are defined in lower prepreg layer 130 in a manner similar to that described above. Via holes 138A and 138B are defined through lower prepreg layer 130 and are aligned with openings 148A and 148B in the manner described above.

Disposed between upper prepreg layer 120 and lower prepreg layer 130 is metal ground layer 140, which in one embodiment comprises a sheet of copper having a thickness in the range of 0.008 mm and 0.017 mm. Metal ground layer 140 has an upper surface 141 that faces upper prepreg layer 120, a lower surface that faces lower prepreg layer 130, side edges 141S, a front edge 141F, and a back edge 141B. Two alignment notches 144, two connector anchor holes 146, and two alignment holes 147 are defined in metal ground layer 140 for purposes similar similar to those described above. Openings 148A are defined through metal layer 140 to prevent shorting during the hole plating process and to facilitate the transmission of signals between via holes 128A and 138A, which are plated in the manner described below to facilitate signal transmission. Smaller pin openings 148B are defined through metal layer 140 to facilitate electrical connection to upper prepreg layer 120 and lower prepreg layer 130 in the manner described below.

Referring to the top of FIG. 1, plug connector assembly 160 USB includes metal case (plug shell) 161 wrapped around a small connector substrate 162, which is often white ceramic, black rigid plastic, or another sturdy substrate. Connector substrate 162 has four standard metal contacts 163 formed thereon, and five Extended USB connector pins similar to those described below with reference to the COB embodiments. Metal contacts 163 and the contact pins (not shown) carry standard and Extended USB signals that are transmitted on metal leads 164, which are shown extending from the rear opening of metal case 161, and are soldered to pads 125 when plug connector assembly 160. An air gap 165 is defined over contact pads 163 for making connection to a host system. Connector jacket claws 166 extend downward from the rear end of metal case 161 for connecting to metal ground layer 140 in the manner described below.

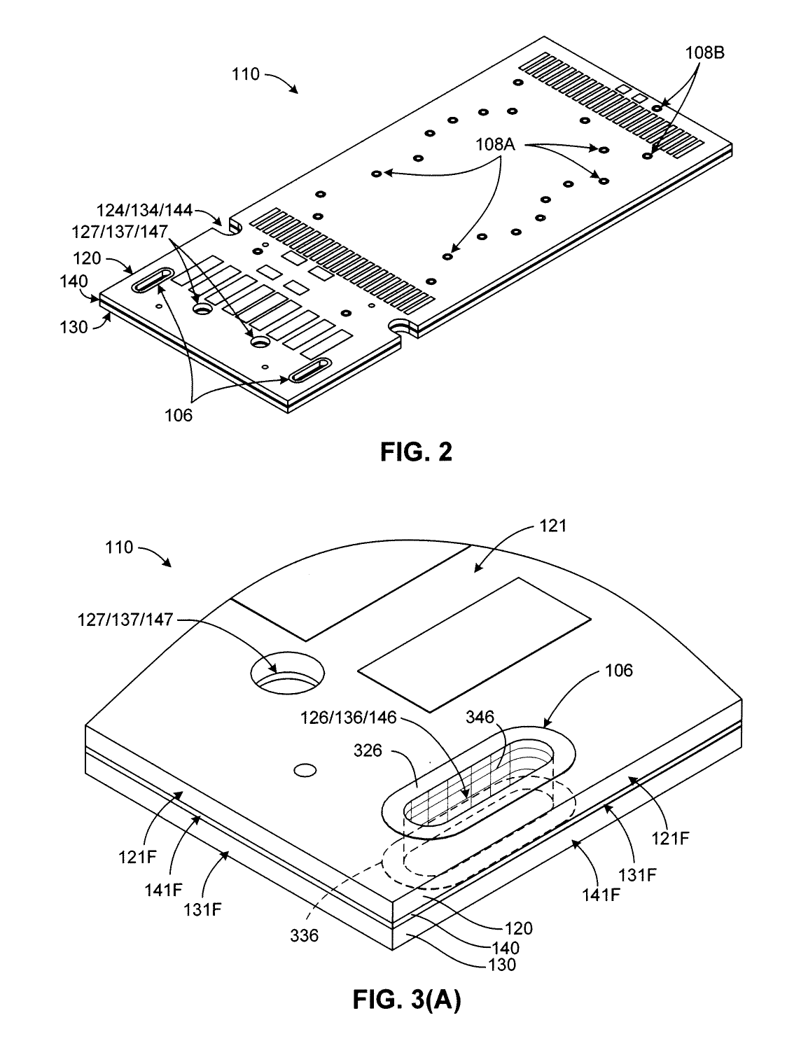

FIG. 2 is a top plan view showing PCB 110 in an assembled state (i.e., with metal ground layer 140 laminated between upper prepreg layer 120 and lower prepreg layer 130 using substantially standard PCB fabrication techniques). Note that the various structural features (e.g., notches 124, 134 and 144, and alignment openings 127, 137, and 147) defined in prepreg layer 120, lower prepreg layer 130 and metal ground layer 140 are aligned and/or formed during the lamination process. As indicated in FIG. 3(A), in accordance with the present embodiment, metal ground layer 140 is laminated between upper prepreg layer 120 and lower prepreg layer 130 such that the peripheral edge of metal ground layer 140 is exposed around the entire peripheral edge of PCB 110 (e.g., front edge 141F is exposed between front edges 121F and 131F, and side edges 141S are exposed between side edges 121S and 131S; likewise, rear edge 141B is exposed between rear edges 121B and 131B). This arrangement maximizes ESD discharge for a given thickness of metal ground layer 140 by maximizing the size of metal ground layer 140.

According to an aspect of the present invention, after the lamination process is completed, a via plating process is performed to deposit a conductive (i.e., metal) layer on the inside surfaces of the various openings defined through upper prepreg layer 120, lower prepreg layer 130 and metal ground layer 140. This via plating process thereby generates various conductive via contact structures that facilitate electrical connections between the various layers of PCB 110, and thus facilitates reliable discharge of ESD events to an external ground source (e.g., the chassis ground disposed on a host system). In the present embodiment, as indicated in FIG. 2, these conductive via contact structures include one or more (two shown) anchor hole structures 106, one or more prepreg-to-prepreg via structures 108A, and one or more prepreg-to-ground via structures 108B, which are described below with reference to FIGS. 3(A) and 3(B). Those skilled in the art will recognize that specific conductive via contact structures other than those described herein may also be formed in other embodiments that utilize the spirit and scope of the present invention.

FIG. 3(A) is an enlarged partial perspective view showing a front corner of PCB 110, and shows one of the two anchor hole structures 106. As described in more detail below, anchor hole structures 106 are electrically connected to connector jacket claws 166 of plug connector assembly 160 to set up the low resistive ESD path from metal ground layer 140 to the surface of the metal connector assembly 160. Anchor hole structures 106 are the key links between PCB 110 and a host device's chassis ground. Similar to alignment holes 127/137/147, anchor holes 126, 136 and 146 are aligned during the lamination process to form an elongated hole extending entirely through the three layers forming PCB 110. During the subsequent via plating process portions of upper surface 121 are masked to prevent the formation of metal on, for example, the area of surface 121 and the internal (cylindrical) surface defined by alignment openings 127/137/147, but the mask is formed with openings in the vicinity of anchor holes 126/136/146 such that metal is deposited to form anchor hole structure 106, which includes an upper (horizontal, flat) portion 326 formed on upper surface 121, a lower (horizontal flat) portion 336 on the lower surface of lower prepreg layer 130, and an intermediate (vertical) portion 346 extending between upper portion 326 and lower portion 336. In one embodiment, anchor hole structure 106 comprises copper, nickel and gold for facilitating adherence to SMT solder material. Note that intermediate portion 346 makes electrical contact with the edge of metal ground layer 140 defining anchor hole 146, whereby all portions of anchor hole structure 106 are electrically connected to metal ground layer 140.

FIG. 3(B) is an enlarged partial perspective view showing a back corner of PCB 110, and shows two prepreg-to-prepreg via structures 108A and two prepreg-to-ground via structures 108B. Similar to anchor hole structure 106 (described above), each via structure 108A and 108B is formed my metal deposited during the via plating process on and inside via holes 128A, 138A, 128B and 138B. In particular, each via structure 108A and 108B includes an upper (horizontal, flat) portion 328A formed on upper surface 121 around via holes 128A, a lower (horizontal flat) portion 338A on the lower surface of lower prepreg layer 130 around via hole 138A, and an intermediate (vertical, cylindrical) portion 348A extending between upper portion 328A and lower portion 338A. In one embodiment, via structures 108A and 108B comprise copper, nickel and gold. Note that due to the size difference between via opening 148A and via openings 128A and 138A, the plated metal forming intermediate portion 348A does not make contact with metal ground plate 140, thereby facilitating the transmission of signals between upper prepreg layer 120 and lower prepreg layer 130. Similarly, each via structure 108B includes an upper (horizontal, flat) portion 328B formed on upper surface 121 around via holes 128B, a lower (horizontal flat) portion 338B on the lower surface of lower prepreg layer 130 around via hole 138B, and an intermediate (vertical) portion 348B extending between upper portion 328B and lower portion 338B. However, in contrast to via structures 108A, the size of via openings 148B is substantially the same as via openings 128B and 138B, so the plated metal forming intermediate portion 348B contacts metal ground plate 140, thereby facilitating the transmission of ESD events from upper prepreg layer 120 and lower prepreg layer 130 to metal ground layer 140.

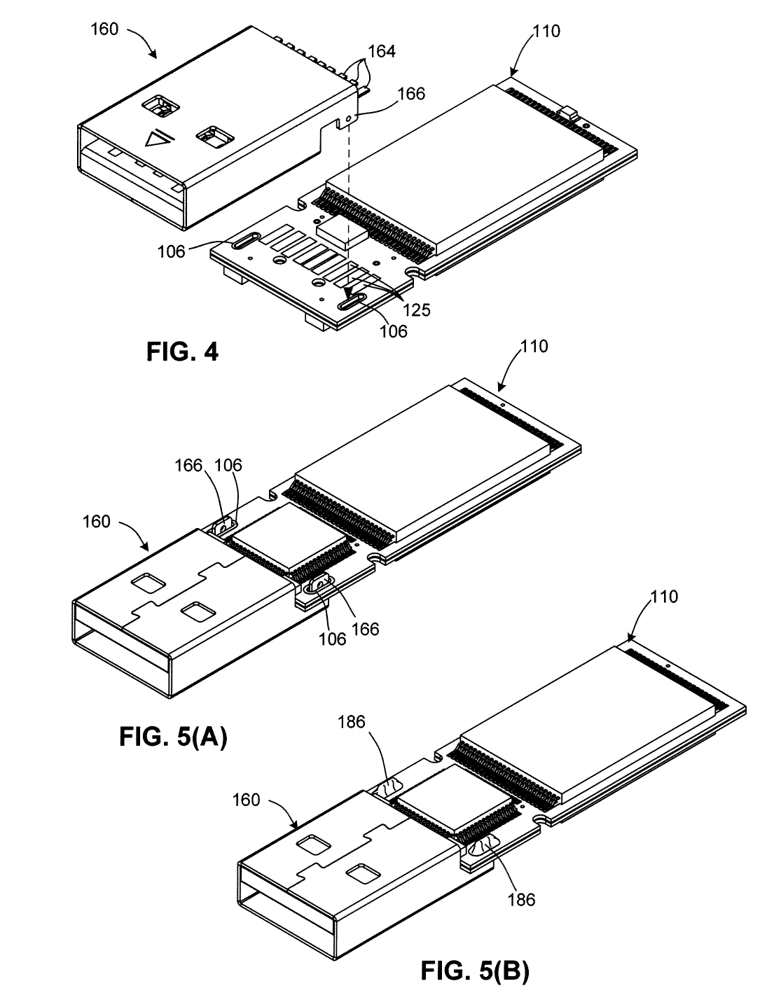

FIG. 4 is an exploded perspective top view illustrating a process of mounting metal connector assembly 160 onto PCB 110 after an SMT process is performed to mount the various IC components onto PCB 110. As indicated by the arrows in FIG. 4, the mounting process involves mounting assembly 160 such that connector jacket claws 166 are inserted into anchor hole structures 106. Note that metal leads 164, which are shown extending from the back side of plug connector assembly 160, are mounted onto connector lead pads 125 when plug connector assembly 160 in mounted onto PCB 110. Most nonvolatile memory chips and controller chips have ESD protection circuits (built in by design before wafer fabrication) on all power pins and signal pins. These ESD protection circuits typically withstand greater than 2 KV of ESD voltages. The present invention enhances this built in ESD protection by providing an important mechanism of draining excessive electrostatic charge before the unwanted voltage built up too high and overwhelms the built in ESD protection.

FIGS. 5(A) and 5(B) are bottom perspective views showing connector assembly 160 mounted onto PCB 110. As indicated in FIG. 5(A), upon mounting connector assembly 160, connector jacket claws 166 are inserted through anchor hole structures 106 and protrude from lower surface of PCB 110. FIG. 5(B) shows the assembly after the SMT reflow process, whereby solder material 186 is disposed over claws 166 and anchor hole structures 106, thereby fixedly connecting assembly 160 to PCB 110, and more particularly to electrically connect metal ground layer 140 of PCB 110 to connector assembly 160, thereby facilitating the discharge of ESD from the components mounted on PCB 110 to the chassis ground of a host system by way of connector assembly 160 when USB device 100 is mounted into a (female) USB socket of the host system.

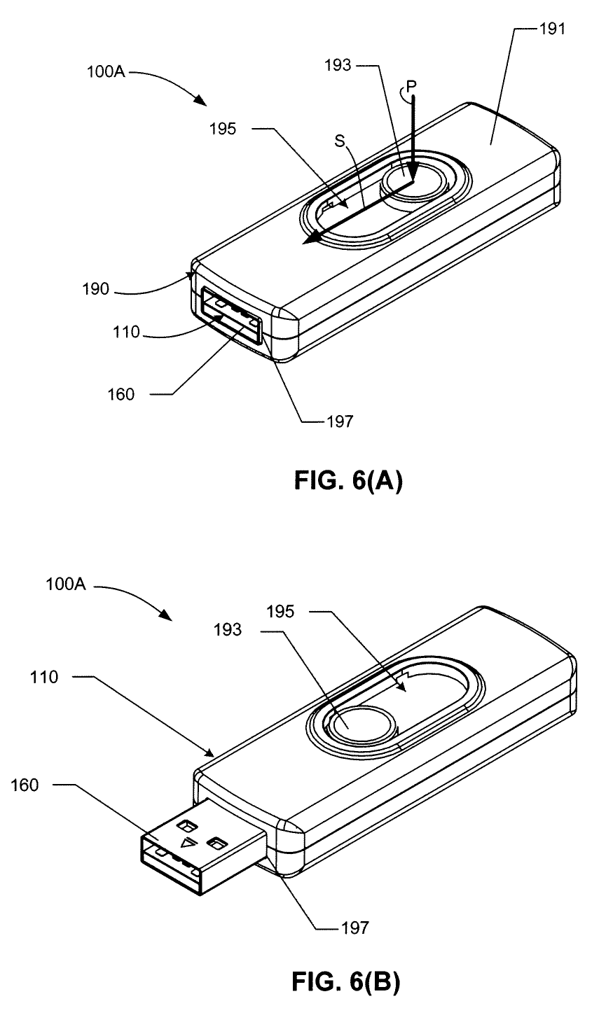

FIGS. 6(A) and 6(B) are perspective views showing an extending/retracting (press/slide) type USB device 100A including a press/slide mechanism 190 having a housing 191 that houses PCB 110 (described above) such that manually positioning a press-slide button 193 along slot 195 causes plug connector assembly 160 of PCB 110 to be moved through a front opening 197 between a retracted position (e.g., as shown in FIG. 6(A)) and a deployed position (e.g., as shown in FIG. 6(B)). As indicated in FIG. 6(A), the press-slide operation is performed by pressing button 193 downward (in the direction of arrow P), then sliding the button along slot 195 (e.g., in the direction of arrow S), and then releasing button 193. The present invention is critical for extend/retract type of USB devices, such as USB device 190, as the push and pull motions cause friction between the fixed and movable parts in the housing package. Electrostatic charge builds up easily through friction of two or more non-conducting materials. Thus, the metal ground layer and the ESD escape paths via the metal connector jacket claw and jacket into the host device chassis ground play a very important role in ESD protection of USB product. In a preferred embodiment, housing 191 comprises metal, which can shield both ESD and EMI (electromagnetic interference) by encompassing the PCBA with metal.

As set forth with reference to the various specific embodiments described below, the present invention extends to other types of USB devices as well.

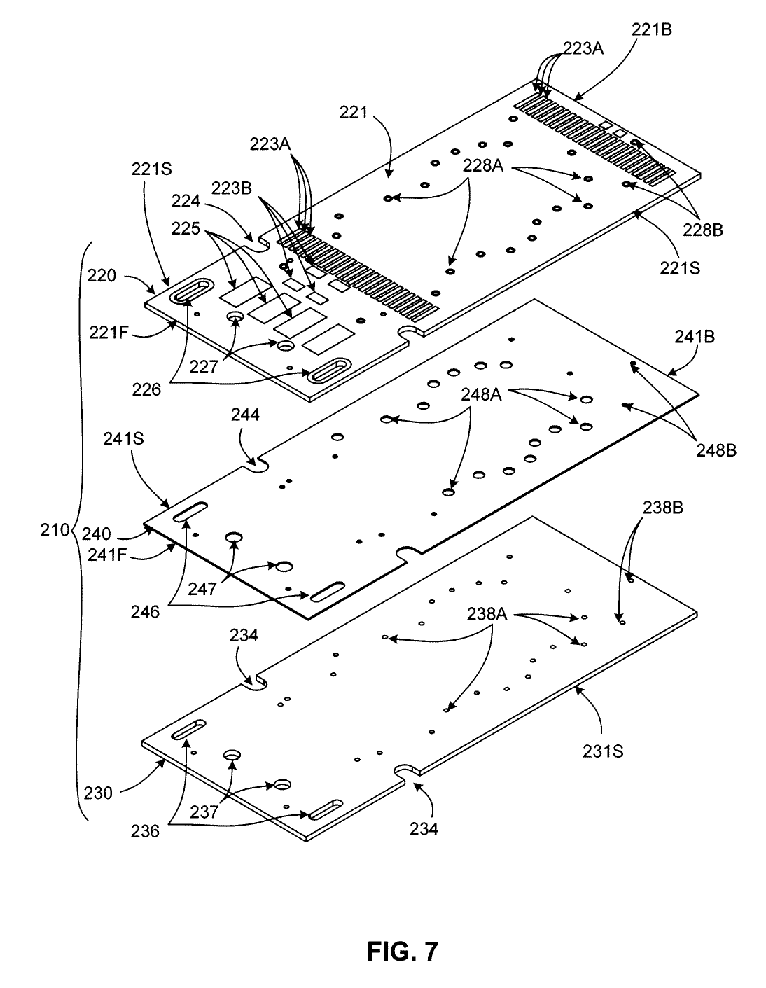

FIGS. 7, 8 and 9 illustrate a laminated ESD preventing PCB 210 for a portable USB 2.0 memory device according to another specific embodiment of the present invention.

FIG. 7 is an exploded top perspective view showing PCB 210 including a metal ground layer 240 sandwiched between an upper (first) prepreg layer 220 and a lower (second) prepreg layer 230. Prepreg layers 220 and 230 are similar to the prepreg layers described above. Upper prepreg layer 220 has an upper surface 221 facing away from metal ground layer 240, side edges 221S, a front edge 221F, and a back edge 221B. Copper pads 223A, 223B and 223C are disposed on upper surface 221 to facilitate surface mounting of various components. Two alignment notches 224 and two alignment holes 227 are disposed adjacent to front edge 221F, and are aligned with notches/holes 234/237 and defined lower prepreg layer 230 and notches/holes 244/247 defined in metal ground layer 240. Two connector anchor holes 226 and multiple via holes 228A and 228B are defined through upper prepreg layer 220 and aligned with anchor holes 236 and openings 238A/238B defined lower prepreg layer 230 and anchor holes 246 and openings 248A/248B in metal ground layer 240 to form vias similar to those described above. PCB 210 mainly differs from PCB 110 (described above) in that four standard USB connector lead pads 225 are formed on upper surface 221 adjacent to front edge 221F, instead of the nine pads utilized in the Extended USB arrangement.

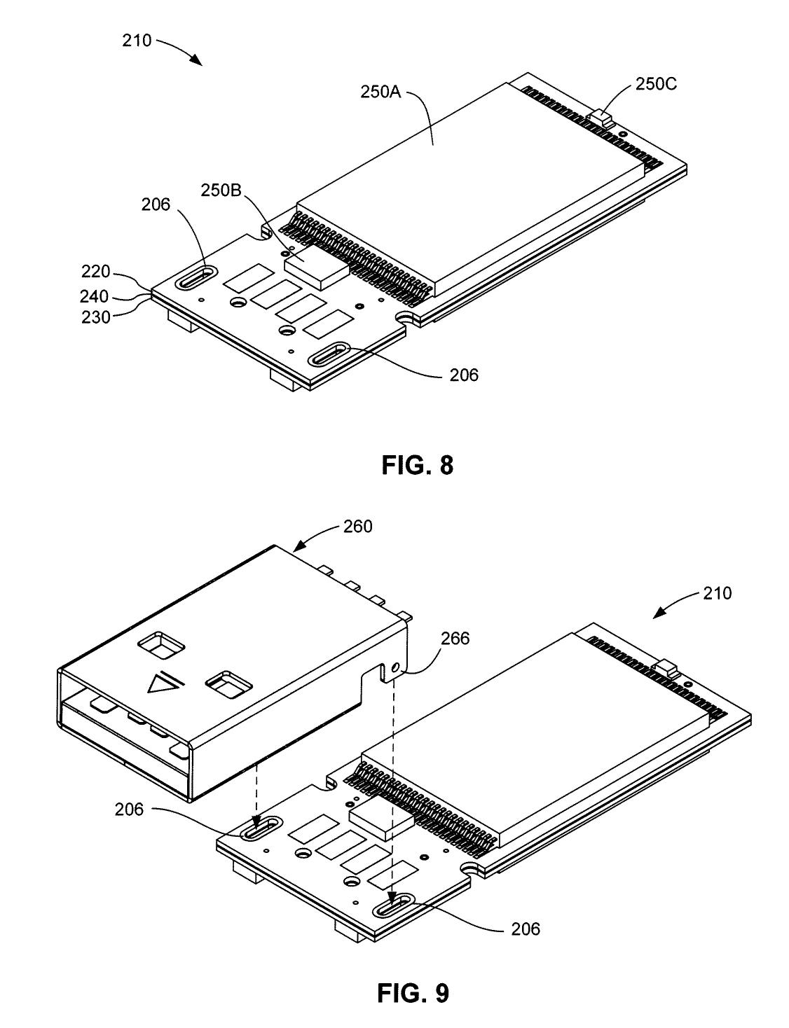

FIGS. 8 and 9 illustrate PCB 210 after further processing. FIG. 8 is a top plan view showing PCB 210 in an assembled state (i.e., with metal ground layer 240 laminated between upper prepreg layer 220 and lower prepreg layer 230 using substantially standard PCB fabrication techniques). Similar to the embodiment described above, after the lamination process is completed, a via plating process is performed to deposit a conductive (e.g., copper, nickel and gold) layer on the various openings defined through upper prepreg layer 220 and lower prepreg layer 230 to generate anchor hole structures 206 and other conductive via contact structures that facilitate electrical connections between the various layers of PCB 210. After the via plating process, at least one IC component (e.g., a nonvolatile memory device 250A, an oscillator component 250B and an LED component 250C) are mounted onto PCB 210 in the manner described above. FIG. 9 is an exploded top perspective view depicting the subsequent step of mounting a plug connector assembly 260 onto PCB 210 such that claws 266 are mounted on anchor hole structures 206 in the manner described above to complete the PCB assembly.

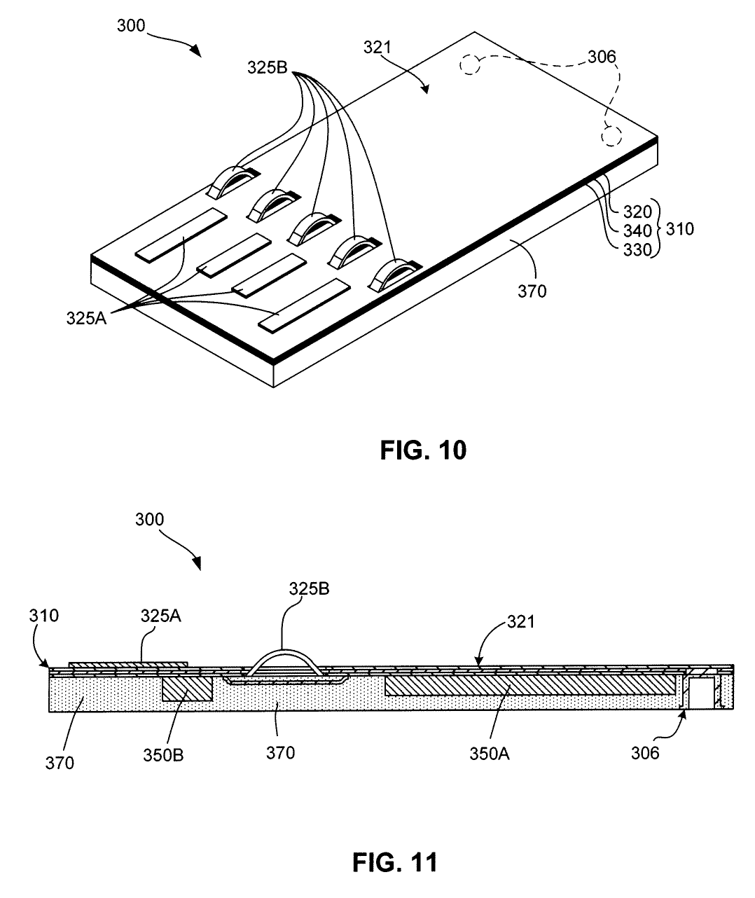

FIGS. 10 and 11 are perspective top and cross sectional side views showing a chip-on-board (COB) type Extended USB device 300 according to another embodiment of the present invention. Similar to the “standard” USB devices described above, COB-type Extended USB device 300 includes an ESD preventing PCB 310 including an upper prepreg layer 320, a lower prepreg layer 330, and a metal ground layer 340 sandwiched between prepreg layers 320 and 330. As indicated in FIG. 11, IC components (e.g., a memory device 350A and an oscillator 350B) are mounted only on the lower surface of PCB 310, wherein the ground terminal 355 of at least one of these components is electrically connected to ground plane layer 340 by a conductive via structure in a manner similar to that described above. The prepreg layers 320 and 330 and metal ground layer 340 are constructed and arranged in a manner similar to that described above, and includes via structures similar to those described above to facilitate signal transfers between the prepreg layers and to the metal ground layer.

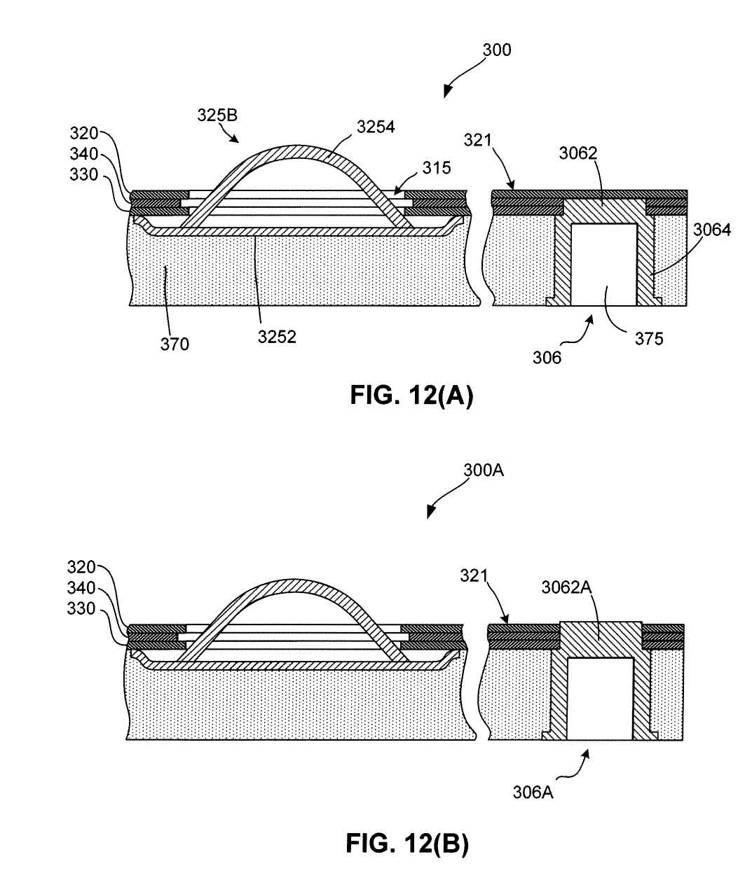

As indicated in FIG. 11, COB-type Extended USB device 300 differs from the “standard” USB devices described above in several respects. First, all components and are encased in plastic or other molding compound that forms a base cover (main body) 370 of USB device 300. Second, the upper surface 321 of PCB 310 is exposed to serve as the top surface of device 300, and contact pads 325A and extended connector pins 325B are disposed on upper surface 321 for transmitting Extended USB signals to and from device 300 in a manner similar to that described above. As indicated in FIGS. 11 and 12(A), each extended connector pin 325B includes a base portion 3252 that is glued or otherwise secured to the bottom surface of prepreg layer 330, and an arched pin portion 3254 that extends from based portion 3252 through an opening 315 defined in PCB 310 such that an apex of arched portion 3254 extends from upper surface 321. A third difference associated with COB-type Extended USB device 300 COB USB is that an anchor hole structure 306 includes a disc-shaped base portion 3062 formed on metal ground layer 340, and a cylindrical internal metal layer 3064 that extends through second prepreg layer 330 and through base cover 370, and facilitates electrical connection of metal ground layer 340 to an external grounding structure (not shown) by way of a pin inserted into a cavity 375 defined by internal metal layer 3064.

FIG. 12(B) is a partial cross-sectional view showing a COB-type Extended USB device 300A according to an alternative embodiment of the present invention. Extended USB device 300A is essentially identical to USB device 300 shown in FIG. 12(A), but differs in that a base portion 3062A of an alternative anchor hole structure 306A extends through all three PCB layers (i.e., upper prepreg layer 320, lower prepreg layer 330 and metal ground layer 340), and is exposed on the first surface 321.

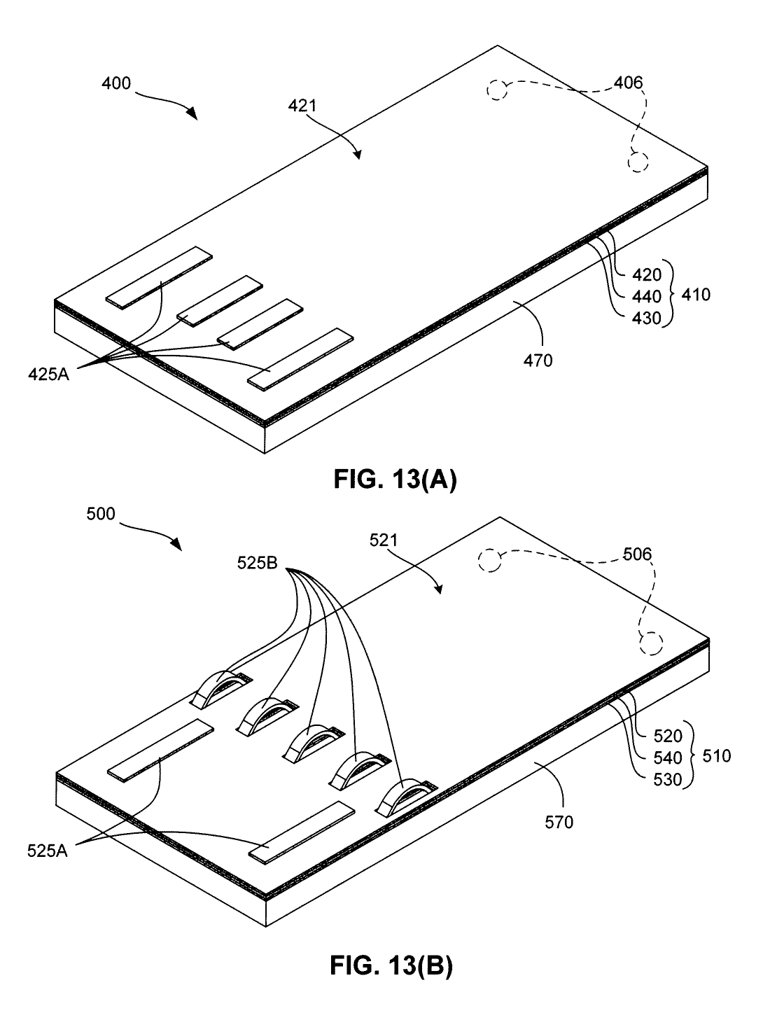

FIGS. 13(A) and 13(B) are perspective views showing COB-type USB devices having ESD preventing PCB 310 according additional embodiments of the present invention. FIG. 13(A) shows a COB-type USB 2.0 device 400 including a PCB 410 having an upper prepreg layer 420, a lower prepreg layer 430 and a metal ground layer 440 formed in accordance with the embodiments described above, four standard USB contact pads 425A disposed on an exposed upper surface 421 of PCB 410, a base cover 470, and two anchor hole structures 406 formed in the manner described above. FIG. 13(B) shows a Non-Backward Compatible (NBC) COB-type USB device 500 including a PCB 510 having an upper prepreg layer 520, a lower prepreg layer 530 and a metal ground layer 540 formed in accordance with the embodiments described above, two contact pads 525A and five contact pins 525B disposed on an exposed upper surface 521 of PCB 510, a base cover 570, and two anchor hole structure 506 formed in the manner described above.

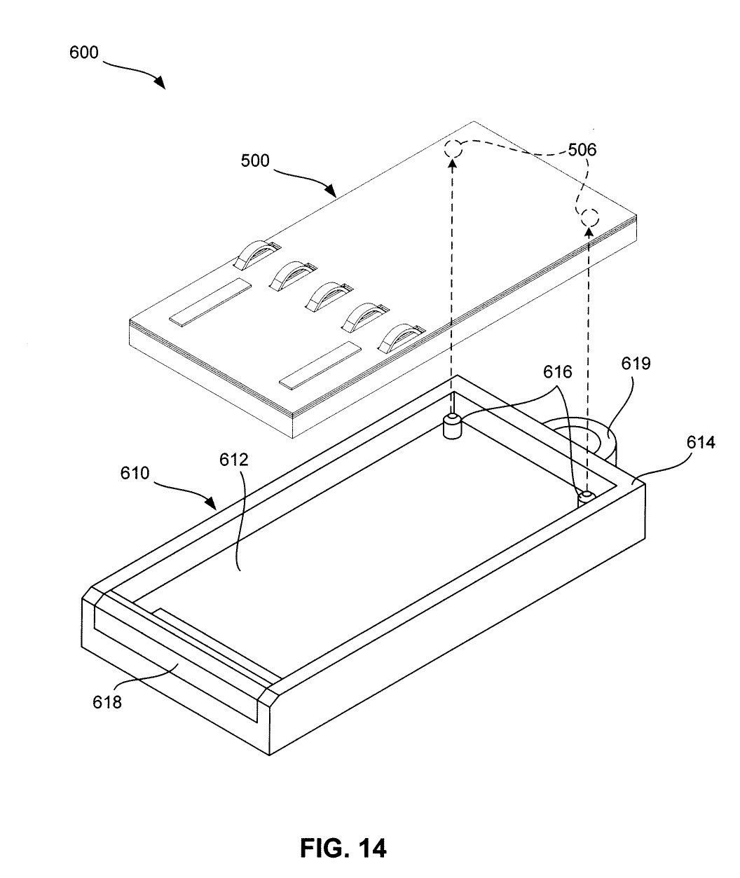

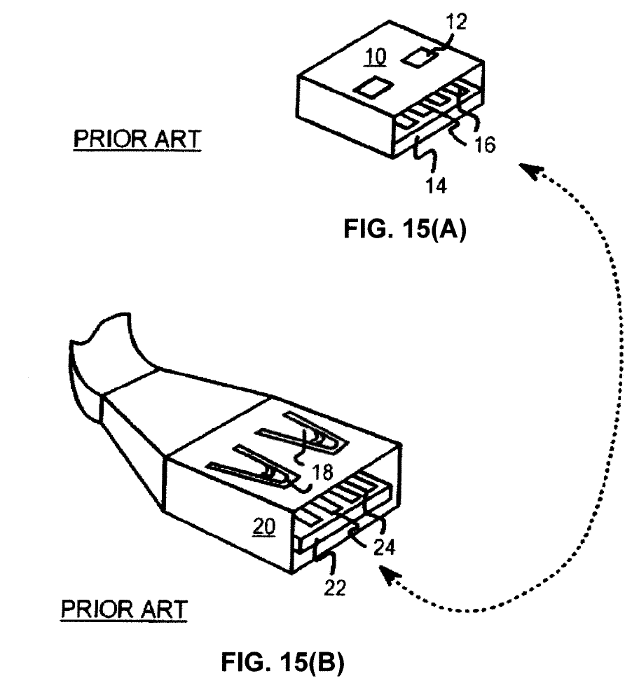

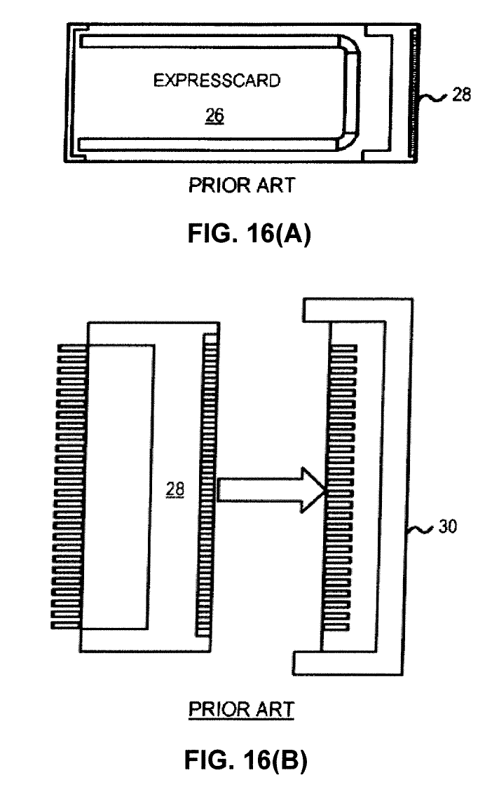

FIG. 14 is an exploded perspective view showing a USB assembly 600 including NBC COB-type USB device 500 (described above with reference to FIG. 13(B)) and a metal housing 610 having a base 612 and peripheral walls 614 that form a shallow opening, ESD connecting poles 616 extending upward from base 612, a plastic insulator lip 618 disposed along a front edge of base 612, and a key ring loop structure 619 extending from a back wall of base 612. As indicated by the dashed lined arrows, USB device 500 is mounted onto metal housing 610 such that ESD connecting poles are inserted into anchor hole structure 506, thereby providing an electrical connection between the metal ground layer and metal housing 610. Metal housing 610 is formed using die cast molding to serve as a ground sink for ESD discharged from NBC COB-type USB device 500. Plastic insulator lip 618 serves to prevent the front housing metal edge from shorting to the host connector pins during plug-in. Of course, any of the COB-type USB devices described herein may be utilized in place of USB device 500.

Table 1 (below) is a list of extended and standard pins in one embodiment of an extended USB connector and socket. The A side of the pin substrates contains the four standard USB signals, which include a 5-volt power signal and ground. The differential USB data D−, D+ are carried on pins 2 and 3. These pins are not used for extended modes.

TABLE 1
Extended and Standard Pins in the Extended USB Connector and Socket

| | Pin- | USB | USB | | MODIFIED | MODIFIED | MODIFIED | MODIFIED |
|---|---|---|---|---|---|---|---|---|
| Side | Out | 1.0 & 2.0 | Extended | SATA | PCIE 0 | PCIE 1 | PCIE 2 | PCIE 3 |
| A | 1 | 5 V | 5 V | 5 V | 5 V | 5 V | 5 V | 5 V |
| A | 2 | D− | D− | D− | D− | D− | D− | D− |
| A | 3 | D+ | D+ | D+ | D+ | D+ | D+ | D+ |
| A | 4 | GND | GND | GND | GND | GND | GND | GND |
| B | 1 | | T− | 3.3 V | 3.3 V | PET− | PET− | PET− |
| B | 2 | | T+ | NC | 1.5 V | PET+ | PET+ | PET+ |
| B | 3 | | GND | T− | PET− | GND | GND | GND |
| B | 4 | | R− | T+ | PET+ | PER− | PER− | PER− |
| B | 5 | | R+ | GND | GND | PER+ | PER+ | PER+ |
| B | 6 | | | R− | PER− | | PET− 1 | PET− 1 |
| B | 7 | | | R+ | PER+ | | PET+ 1 | PET+ 1 |
| B | 8 | | | 12 V | NC | | GND | GND |
| B | 9 | | | | | | PER− 1 | PER− 1 |
| B | 10 | | | | | | PER+ 1 | PER+ 1 |
| B | 11 | | | | | | | PET− 2 |
| B | 12 | | | | | | | PET+ 2 |
| B | 13 | | | | | | | GND |
| B | 14 | | | | | | | PER− 2 |
| B | 15 | | | | | | | PER+ 2 |
| B | 16 | | | | | | | PET− 3 |
| B | 17 | | | | | | | PET+ 3 |
| B | 18 | | | | | | | GND |
| B | 19 | | | | | | | PER− 3 |
| B | 20 | | | | | | | PER+ 3 |

Side B of the pin substrates, or the extension of the primary surfaces, carries the extended signals. Pin 1 is a 3.3-volt power signal for modified PCI-Express generation 0 and Serial-ATA (SATA), while pin 2 is a 1.5-volt supply for modified PCI-Express generation 0 and reserved for SATA. For modified PCI-Express generations 1, 2, and 3, pins 1 and 2 carry the transmit differential pair, called PET−, PET+, respectively. Pin 8 is a 12-volt power supply for SATA and reserved for modified PCI-Express generation 0. Pin 8 is a ground for modified PCI-Express generations 2 and 3. Pin 5 is a ground for modified PCI-Express generation 0 and SATA.

Pins 3 and 4 carry the transmit differential pair, PET−, PET+, respectively, for modified PCI-Express generation 0, and T−, T+, respectively, for SATA. Pin 3 is a ground for modified PCI-Express generations 1, 2, and 3. Pin 4 and pin 5 carry receive differential pair, called PER− and PER+, respectively, for modified PCI-Express generations 1, 2, and 3. Pins 6 and 7 carry the receive differential pair, PER−, PER+, respectively, for modified PCI-Express generation 0 and R−, R+, respectively, for SATA. Pins 6 and 7 carry a second transmit differential pair, called PET−1 and PET+1, respectively, for modified PCI-Express generations 2 and 3.

Pins 9 and 10 carry a second receive differential pair, called PER−1 and PER+1, respectively, for modified PCI-Express generations 2 and 3.

Pins 11 and 12 carry a third transmit differential pair, called PET−2 and PET+2, respectively, for modified PCI-Express generation 3. Pin 13 is a ground for modified PCI-Express generation 3. Pins 14 and 15 carry a third receive differential pair, called PER−2 and PER+2, respectively, for modified PCI-Express generation 3.

Pins 16 and 17 carry a fourth transmit differential pair, called PET−3 and PET+3, respectively, for modified PCI-Express generation 3. Pin 18 is a ground for modified PCI-Express generation 3. Pins 19 and 20 carry a fourth receive differential pair, called PER−3 and PER+3, respectively, for modified PCI-Express generation 3.

The ExpressCard pins REFCLK+, REFCLK−, CPPE#, CLKREQ#, PERST#, and WAKE# are not used in the extended USB connector to reduce the pin count. Additional pins may be added to the extended USB connector and socket if some or all of these pins are desired. Furthermore, the pin names and signal arrangement (or order) illustrated in Table 1 is merely one embodiment. It should be apparent that other pin names and signal arrangement (or order) may be adopted in other embodiments.

In some embodiments, a variety of materials may be used for the connector substrate, circuit boards, metal contacts, metal case, etc. Plastic cases can have a variety of shapes and may partially or fully cover different parts of the circuit board and connector, and can form part of the connector itself. Various shapes and cutouts can be substituted. Pins can refer to flat metal leads or other contactor shapes rather than pointed spikes. The metal cover can have the clips and slots that match prior-art USB connectors.

Rather than use PCI-Express, the extended USB connector/socket can use serial ATA, Serial Attached SCSI, or Firewire IEEE 1394 as the second interface in some embodiments. The host may support various serial-bus interfaces as the standard interface, and can first test for USB operation, then IEEE 1394, then SATA, then SA SCSI, etc, and later switch to a higher-speed interface such as PCI-Express. During extended mode when the eight extended contacts are being used for the extended protocol, the 4 USB contacts can still be used for USB communication. Then there are two communication protocols that the host can use simultaneously.

In the examples, USB series A plugs and receptacles are shown. However, the invention is not limited to Series A. Series B, Series mini-B, or Series mini-AB can be substituted. Series B uses both upper and lower sides of the pin substrate for the USB signals. The left-side and right-side of the pin substrate can be used for the additional 8 pins. Series mini-B and Series mini-AB use the top side of the pin substrate for the USB signals. The additional 8 pins can be placed on the bottom side of the pin substrate 34 for these types of connectors. The extended USB connector, socket, or plug can be considered a very-high-speed USB connector or VUSB connector since the higher data-rates of PCI-Express or other fast-bus protocols are supported with a USB connector.

A special LED can be designed to inform the user which electrical interface is currently in use. For example, if the standard USB interface is in use, then this LED can be turned on. Otherwise, this LED is off. If more than two modes exist, then a multi-color LED can be used to specify the mode, such as green for PCI-Express and yellow for standard USB.

Although the present invention has been described with respect to certain specific embodiments, it will be clear to those skilled in the art that the inventive features of the present invention are applicable to other embodiments as well, all of which are intended to fall within the scope of the present invention.

1. A portable memory device comprising:
an ESD preventive printed circuit board (PCB) including:
a first prepreg layer having a plurality of metal contact pads disposed on a first surface thereof;
a second prepreg layer;
a metal ground layer sandwiched between the first and second prepreg layers such that the first surface of the first prepreg layer faces away from the metal ground layer; and
at least one integrated circuit component mounted on one of the first and second prepreg layers,
wherein the integrated circuit component includes a ground terminal electrically connected to said ground plane layer by a conductive via structure extending through said one of the first and second prepreg layers.

2. The portable memory device of claim 1,
wherein the first and second prepreg layers comprise FR4, and
wherein the metal ground layer comprises a sheet of copper having a thickness in the range of 0.008 mm and 0.017 mm, and
wherein the metal ground layer is laminated between the first and second prepreg layers such that an edge of the ground layer is exposed along the entire peripheral edge of the ESD preventive PCB.

3. The portable memory device of claim 1, wherein at least one of the first and second prepreg layers defines a via hole, and
wherein said conductive via structure comprises a metal layer formed on an inside surface of the via hole to facilitate electrical connection of the metal ground layer and the integrated circuit component.

4. The portable memory device of claim 3, wherein the metal layer formed on the inside surface of the via hole comprises one or more of copper, nickel and gold.

5. The portable memory device of claim 1, further comprising an anchor hole structure extending through at least one of the first and second prepreg layers and having an internal metal layer to facilitate electrical connection of the metal ground layer to an external grounding structure.

6. The portable memory device of claim 5, wherein the internal metal layer forming the anchor hole structure comprises one or more of copper, nickel and gold.

7. The portable memory device of claim 5,
wherein the ESD preventive PCB further comprises connector lead pads disposed on the first surface of the first prepreg layer, and
wherein the portable device further comprises a metal connector jacket mounted onto the ESD preventive printed circuit board (PCB), the metal connector jacket including a metal case wrapped around a small connector substrate, having metal contacts formed thereon and connected to metal leads that are soldered to said connector lead pads, wherein connector jacket claws extending from the metal case are electrically connected to said anchor hole structure, whereby the metal ground layer serves as a discharge path for built up or induced electrostatic charge to a chassis ground of a host system by way of said metal connector jacket when said portable memory device is inserted into a socket of the host system.

8. The portable memory device of claim 7, wherein the portable memory device comprises a press/slide mechanism including a housing surrounding the PCB, and a button that is connected to the PCB and manually movable in a slot defined in the housing such that the metal connector jacket is movable through a front opening defined in the housing between a retracted position and a deployed position.

9. The portable memory device of claim 8, wherein the housing comprises metal.

10. The portable memory device of claim 7, wherein the portable memory device comprises one of a USB 2.0 device and an Extended USB device.

11. The portable memory device of claim 1, wherein the at least one integrated circuit component is mounted on the second prepreg layer ad is encased in a molding compound, and wherein the first surface is exposed.

12. The portable memory device of claim 1, wherein the at least one integrated circuit component is mounted on the second prepreg layer ad is encased in a molding compound, and wherein the first surface is exposed and includes one or more contact pads formed thereon.

13. The portable memory device of claim 12, further comprising one or more contact pins having a base portion mounted to on the second prepreg layer, and an arched pin portion extending from the base portion through an opening defined through the PCB such that a portion of the arched pin portion extends from the first surface.

14. The portable memory device of claim 12, further comprising an anchor hole structure having a base portion disposed on metal ground layer, and a cylindrical internal metal layer extending through the second prepreg layer and the molding compound to facilitate electrical connection of metal ground layer to an external grounding structure.

15. The portable memory device of claim 14, wherein the base portion extends through the first prepreg layer and is exposed on the first surface.

16. The portable memory device of claim 15, further comprising a metal housing having a base including at least one ESD connecting pole that is received inside the anchor hole structure.

17. The portable memory device of claim 12, wherein the portable memory device comprises one of a COB-type USB 2.0 device and a COB-type Extended USB device.

18. The portable memory device of claim 12, wherein the portable memory device comprises two contact pads and five contact pins disposed on the first surface.
